(19) United States
(12) Patent Application Publication
(10) Pub. No.: US 2004/0228960 A1
(43) Pub. Date: Nov. 18, 2004

(54) Dipping agent for meat

(76) Inventors: Hiromichi Kouno, Yokkaichi-shi (JP); Keiichi Kondo, Yokkaichi-shi (JP); Takashi Hagi, Yokkaichi-shi (JP)

Correspondence Address: BIRCH STEWART KOLASCH & BIRCH, PO BOX 747, FALLS CHURCH, VA, 22040-0747, US

(21) Appl. No.: 10/842,551

(22) Filed: May 11, 2004

(30) Foreign Application Priority Data
May 12, 2003 (JP) 2003-132984

(51) Int. Cl. A23L 1/31

(52) U.S. Cl. 426/652

(57) ABSTRACT

A dipping agent for meat comprising an enzyme hydrolysate of an egg white protein; and a composition for dipping meat comprising the above dipping agent. The dipping agent can be used in food industries.

### BACKGROUND OF THE INVENTION

1. Field of the Invention

The present invention relates to a dipping agent for meat and a composition for dipping meat, comprising the dipping agent. More specifically, the present invention relates to a dipping agent for meat, and a composition for dipping meat, comprising the dipping agent, which can give the meat an excellent yield and an excellent palatability after frozen storage or even after cooking.

2. Discussion of the Related Art

In general, muscle proteins undergo thermal denaturation by heating meat, so that there arise various problems such as drips are produced, roasting shrinkage are generated, and the dry palatability and toughness are tasted. While these changes in meat due to heating bring out good taste (umami) of meat and give excellent deliciousness, those changes also cause some problems such as the appearance thereof is drastically impaired, the meat quality becomes tighter, the palatability of meat becomes dry and loses its juicy taste, the yield is lowered and the like, from the viewpoint of meat processing.

Generally, frozen meat has been used in great majority of raw materials used in meat product foods. In addition, recently, those foods which are subjected to cooking, frozen and thereafter distributed have been increased. Since the water holding capacities of these frozen foods are decreased when stored for a long period of time, the problems generated in processing the meat as mentioned above are more remarkably exhibited.

In order to solve the problem of lowering in the yield, conventionally, polyphosphate salt or a sugar has been added. However, when these components are added, there arise some problems of reduction in flavor or palatability. As a measure against such problems, a method of adding a citrate is disclosed (see, for instance, U.S. Pat. No. 3,134,678). However, the sufficient effects are not obtained.

In addition, an injection method has been known as a technique of improving meat with an egg white. However, since a needle is penetrated into meat, there arise some problems that those having smaller sizes cannot be subjected to penetration because a certain size is required for the subject for penetration. Also, the injection method is not preferable because a meat piece is damaged.

The present invention provides a dipping agent for meat which prevents the yield from being lowered and the palatability, taste and flavor from being deteriorated in the frozen storage or cooking.

These and other advantages of the present invention will be apparent from the following description.

### SUMMARY OF THE INVENTION

As a result of intensive studies in view of solving the above problems, the present inventors have found that an enzyme hydrolysate of an egg white protein has an effect of preventing the yield from being lowered, and the palatability, taste and flavor from being deteriorated in the frozen storage or cooking, which resulted in completion of the present invention.

Specifically, the present invention relates to a dipping agent for meat comprising an enzyme hydrolysate of a protein derived from an egg white; and a composition for dipping meat, comprising the dipping agent.

### DETAILED DESCRIPTION OF THE INVENTION

The present invention will be described in detail below.

The term “meat” as used herein refers to meat which is generally provided for eating, such as raw material meat of red meat such as beef, pork, chicken, mutton or horsemeat, and raw material meat of fish and shellfish, such as whale meat, tuna, skipjack, salmon, sardine, codfish, shrimp, squid, octopus, shell, adductor muscle of scallop or the like. The portion, grade, shape and the like of the meat may not be particularly limited. The meat may be raw meat or frozen meat.

The term “dipping” as used herein is not particularly limited so long as the process includes a step of dipping meat in an aqueous solution of a salt or the like, for the purpose of improving properties of the meat in the step of processing meat. However, it is desirable from the aspect of giving satisfactory effects that the meat is allowed to stand or tumbled in the aqueous solution for a given period of time, preferably for 30 minutes or longer, more preferably for 2 hours or longer. The effect of improving meat includes improvement in water holding capacity, improvement in palatability, improvement in flavor and the like.

The term “dipping agent” as used herein refers to an agent used in the step of dipping meat, and comprises an enzyme hydrolysate of a raw material egg white protein.

The term “egg white” as used herein is not particularly limited so long as the egg white is separated from a chicken egg. The form may be in any form of a raw egg white solution, a frozen egg white solution and an egg white powder. From the viewpoint of processibility, a raw egg white solution or a frozen egg white solution is preferable.

The term “egg white protein” as used herein is a protein derived from an egg white of an chicken egg, and refers to those in which various proteins such as ovalbumin and conalbumin are in admixture thereof. The egg white protein may be an egg white obtained by purification, extraction, concentration or dilution, or may be an egg white in which a part of components, for instance, a saccharide, lysozyme or the like is removed therefrom.

The term “enzyme” as used herein is not particularly limited, so long as the enzyme is a protease (proteolytic enzyme) derived from a plant, an animal or a bacterium, and a protease extracted from cells of genus Bacillus is preferable because there is little bitterness produced. More preferable are proteases extracted from cells of Bacillus lichenniformis, Bacillus thermoproteolyticus Rokko, Bacillus subtilis and the like. When these proteases are used, it is more preferable because the enzyme hydrolysate hardly gives bitterness so that the flavor of a food is not deteriorated. As these proteases, for instance, there can be utilized commercially available products such as ORIENTASE 90N, 10L or 22 BF (each commercially available from HBI); PROTIN or THERMOASE (registered trade mark, each commercially available from Daiwa Kasei K. K.); PROTEASE N, NL or S (each commercially available from Amano Enzyme Inc.); and the like.

The enzyme hydrolysate used in the present invention is obtained by hydrolyzing the above egg white protein with the enzyme. The resulting enzyme hydrolysate may be used directly, or may be used by spray-drying by a method known in the art.

The conditions for enzyme hydrolysis treatment are not particularly limited. It is preferable to carry out hydrolysis at a pH of from 7 to 10 and a temperature of from 55° to 65° C. It is preferable that the pH is 7 or higher, and the hydrolysis temperature is 55° C. or higher, from the viewpoint of the reaction rate for hydrolysis. It is desirable that the pH is 10 or lower, from the viewpoint of controlling alkaline denaturation of the raw material protein. In addition, it is preferable that the hydrolysis temperature is 65° C. or lower, from the viewpoint of controlling the thermal denaturation of the raw material protein. In addition, when the desired enzyme hydrolysate is obtained, it is preferable that the enzyme is inactivated by heating so that hydrolysis would not be further progressed.

The degree of degradation of the enzyme hydrolysate used in the present invention is not particularly limited. It is preferable that the enzyme hydrolysate is degraded to a degree so that the amount of amino groups is 7-folds or greater and 20-folds or less, more preferably 8-folds or greater and 20-folds or less, even more preferably 10-folds or greater and 20-folds or less as compared with the amount of amino groups of the raw material egg white protein. In addition, the average amino acid strand length of the enzyme hydrolysate is preferably 2 or more and 15 or less, more preferably 3 or more and 10 or less, even more preferably 3 or more and 8 or less, and the content of free amino acids is preferably 40% or lower, more preferably 30% or lower, even more preferably 20% or lower. When the amount of amino groups is 7-folds or greater and 20-folds or less as compared with the amount of the raw material egg white protein, the effect of preventing the yield from being lowered, and the palatability, taste, and flavor from being deteriorated in the frozen storage or cooking is satisfactorily exhibited. Also, the term “amount of amino groups” as used herein refers to an amount of amino groups at a terminal and a lysine residue of a protein or a hydrolysate of a protein. The amount of amino groups, the average amino acid strand length, and the content of free amino acids can be determined by a formol titration method, a TNBS coloration method, a ninhydrin coloration method or the like.

The dipping agent of the present invention may further comprise an additive such as an emulsifier, other protein material, a polysaccharide or a seasoning within the range in which the effects of the present invention would not be inhibited. These additives may be used alone or in admixture of two or more kinds.

When the dipping agent of the present invention does not contain the above additive, the above enzyme hydrolysate of an egg white protein may be used directly as a dipping agent. Alternatively, when the dipping agent contains the above additive, for instance, the enzyme hydrolysate and the additive are mixed to be used as a dipping agent.

The present invention further provides a composition for dipping meat, comprising the above dipping agent for meat.

It is preferable that the composition for dipping meat of the present invention further comprises a salt of an organic acid and/or a phosphate from the viewpoints of the yield from being lowered, and the palatability, taste and flavor from being deteriorated in the frozen storage or cooking.

Concrete examples of the salt of an organic acid include, but are not particularly limited to, a potassium salt, a sodium salt, a magnesium salt or the like of citric acid, malic acid, succinic acid, lactic acid, acetic acid and the like. Among them, sodium citrate, sodium malate and sodium succinate are especially preferable. These salts of an organic acid may be used alone, or in admixture of two or more kinds.

Concrete examples of the phosphate include, but are not particularly limited to, a potassium salt, a sodium salt, a magnesium salt or the like of monophosphoric acid, pyrophosphoric acid, tripolyphosphoric acid, metaphosphoric acid and the like. These phosphates may be used alone, or in admixture of two or more kinds.

The content of the enzyme hydrolysate of an egg white protein in the composition for dipping meat of the present invention is preferably 0.01% by weight or more and 1% by weight or less, more preferably 0.03% by weight or more and 0.8% by weight or less, even more preferably 0.05% by weight or more and 0.5% by weight or less. When the content is 0.01% by weight or more, it is preferable because the effect of preventing the yield from being lowered and the palatability, taste and flavor from being deteriorated is satisfactory. When the content is 1% by weight or less, it is preferable because the reduction in flavor is suppressed.

In addition, it is preferable that the composition of the present invention is alkaline, and it is more preferable that a pH of the composition is from 9.0 to 12.0, from the viewpoints of prevention of the yield from being lowered and the palatability, taste and flavor from being deteriorated in the frozen storage or cooking.

The composition for dipping meat of the present invention is prepared, for instance, by dissolving the above dipping agent for meat and optionally a salt of an organic acid and/or a phosphate in water. The resulting composition for dipping meat is used as a dipping solution in the step of dipping meat.

### EXAMPLES

The present invention will be described more specifically by means of the following Examples, without intending to limit the scope of the invention thereto.

### Example 1

A 3 N citric acid solution was added to 1000 g of a liquid egg white to adjust its pH to 8.5, and 7 g of Orientase 22BF (derived from Bacillus subtilis, manufactured by HBI) was added thereto. The mixture was reacted at 60° C. for 10 hours. The enzyme was inactivated by heating at 90° C. for 15 minutes, a pH of the reaction mixture was adjusted to 7.0, and thereafter the mixture was spray-dried to give an enzyme hydrolysate 1 of an egg white protein. The amount of amino group of the enzyme hydrolysate 1 of an egg white protein was determined by a TNBS method. As a result, the amount was 17.6-folds the amount of amino group of a liquid egg white before hydrolysation.

### Example 2

An inventive product 1 having a pH of 10.0, comprising 1.2 kg of trisodium citrate, 0.3 kg of potassium chloride, 0.2 kg of sodium carbonate, 0.2 kg of sodium bicarbonate, 10.1 kg of the enzyme hydrolysate of an egg white protein obtained in Example 1, and 98 kg of water was prepared. For the sake of comparison, a control product 1 having a pH of 10.1, comprising 1.3 kg of trisodium citrate, 0.3 kg of potassium chloride, 0.2 kg of sodium carbonate, 0.2 kg of sodium bicarbonate and 98 kg of water, a control product 2 having a pH of 10.4, comprising 0.8 kg of potassium chloride, 0.6 kg of sodium carbonate, 0.6 kg of sodium bicarbonate and 98 kg of water, and a control product 3 prepared by adjusting the pH of the control product 1 to 8.0 with citric acid also were prepared.

### Example 3

An inventive product 2 having a pH of 9.0, comprising 1.1 kg of potassium pyrophosphate, 0.2 kg of sodium pyrophosphate, 0.2 kg of sodium tripolyphosphate, 0.2 kg of potassium chloride, 0.1 kg of sodium metaphosphate, 0.1 kg of trisodium phosphate, and 10.1 kg of the enzyme hydrolysate of the egg white protein obtained in Example 1 was prepared. For the sake of comparison, a control product 4 having a pH of 10.9, comprising 1.2 kg of potassium pyrophosphate, 0.2 kg of sodium pyrophosphate, 0.2 kg of sodium tripolyphosphate, 0.2 kg of potassium chloride, 0.1 kg of sodium metaphosphate, and 0.1 kg of trisodium phosphate, a control product 5 having a pH of 6.8, comprising 2 kg of potassium chloride and 98 kg of water, a control product 6 having a pH of 7.0, comprising 2 kg of sodium metaphosphate and 98 kg of water, and a control product 7 having a pH of 12.5, comprising 2 kg of trisodium phosphate and 98 kg of water also were prepared.

### Test Example 1

Frozen shrimps were thawed, and then 500 g of each of the inventive product 1 and the control products 1 to 3 was added to 500 g of the shrimps, and the shrimps were then respectively dipped at 5° C. for 2 hours. After the determination of the yield, the dipped shrimps were boiled in boiling water for 3 minutes, and the yield was determined. Palatability and taste were evaluated by a sensory examination. In addition, those shrimps which were not subjected to dipping treatment after thawing were boiled, and the yield was determined. Palatability and taste were evaluated by a sensory examination. The sensory examination was performed by 10 panelists, the best scoring 10 and the worst scoring 1, and the score being expressed as an average of 10 panelists. The results are shown in Table 1. The evaluation was made by ranking with 1 to 10 stepwise scores based on the above-mentioned criteria.

TABLE 1

| | Inventive | Control | Control | Control | |
|---|---|---|---|---|---|
| | Product 1 | Product 1 | Product 2 | Product 3 | Untreated |
| pH | 10.0 | 10.1 | 10.4 | 8.0 | — |
| Yield After | 108.0% | 104.3% | 103.3% | 102.2% | 100.0% |
| Dipping | | | | | |
| Yield After | 77.3% | 64.5% | 59.9% | 61.1% | 58.9% |
| Boiling | | | | | |
| Palatability | 9.3 | 5.3 | 3.1 | 3.9 | 2.2 |
| Taste | 8.8 | 4.1 | 2.9 | 3.3 | 1.1 |

As is clear from Table 1, the present invention can enhance the yield, the palatability and the taste.

### Test Example 2

Frozen chickens were thawed, and then 125 g of each of the inventive product 1 and the control products 4 to 7 was added to 500 g of the chickens, and the chickens were then respectively tumbled at 5° C. for 60 minutes. After the determination of the yield, the tumbled chickens were baked in an oven at 200° C. for 5 minutes, and thereafter the yield was determined. Palatability and taste were evaluated by a sensory examination. In addition, those chickens which were not subjected to tumbling treatment after thawing were baked, and the yield was determined. Palatability and taste were evaluated by a sensory examination. The sensory examination was carried out by 10 panelists, the best scoring 10 and the worst scoring 1, and the score being expressed as an average of 10 panelists. The results are shown in Table 2. The evaluation was carried out by ranking with 1 to 10 stepwise scores based on the above-mentioned criteria.

TABLE 2

| | Inventive | Control | Control | Control | Control | |
|---|---|---|---|---|---|---|
| | Product 2 | Product 4 | Product 5 | Product 6 | Product 7 | Untreated |
| pH | 9.0 | 10.9 | 6.8 | 7.0 | 12.5 | — |
| Yield After | 122.3% | 120.7% | 117.4% | 119.0% | 121.2% | 100.0% |
| Tumbling | | | | | | |
| Yield After | 81.1% | 72.5% | 60.1% | 66.8% | 72.2% | 59.6% |
| Baking | | | | | | |
| Palatability | 9.4 | 7.5 | 4.0 | 5.4 | 5.8 | 3.8 |
| Taste | 9.0 | 6.2 | 3.5 | 5.1 | 4.3 | 3.1 |

As is clear from Table 2, the present invention can improve a yield, palatability and taste.

Since the dipping agent for meat obtained by the present invention prevents the yield from being lowered, and the palatability, taste and flavor from being deteriorated in frozen storage or cooking of meat product, the dipping agent can greatly contribute to food industries.

The present invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A dipping agent for meat comprising an enzyme hydrolysate of an egg white protein.

2. The dipping agent according to claim 1, wherein said enzyme hydrolysate is obtained by hydrolyzing with a protease extracted from a microorganism belonging to the genus Bacillus.

3. The dipping agent according to claim 1, wherein the amount of amino group of said enzyme hydrolysate is 7-fold or greater and 20-fold or less as compared with the amount of amino group of a raw material egg white protein.

4. The dipping agent according to claim 2, wherein the amount of amino group of said enzyme hydrolysate is 7-fold or greater and 20-fold or less as compared with the amount of amino group of a raw material egg white protein.

5. A composition for dipping meat comprising the dipping agent of any one of claims 1 to 4.

6. The composition according to claim 5, further comprising one or more compounds selected from the group consisting of salts of organic acids and phosphates.

7. The composition according to claim 5, wherein the composition is alkaline.

8. The composition according to claim 7, wherein the composition has a pH of from 9.0 to 12.0.

9. The composition according to claim 5, wherein said enzyme hydrolysate is contained in an amount of from 0.01 to 1% by weight.

10. The composition according to claim 6, wherein said enzyme hydrolysate is contained in an amount of from 0.01 to 1% by weight.

11. A method for dipping meat, comprising the step of dipping the meat into the dipping agent of any one of claims 1 to 4.

12. A method for dipping meat, comprising the step of dipping the meat into the composition of claim 5.

13. A method for increasing yield of frozen meat, comprising the step of dipping said meat into the dipping agent of any one of claims 1 to 4.

14. A method for increasing yield of frozen meat, comprising the step of dipping the meat into the composition of claim 5.

15. A method for improving palatability of frozen meat, comprising the step of dipping said meat into the dipping agent of any one of claims 1 to 4.

16. A method for improving palatability of frozen meat, comprising the step of dipping the meat into the composition of claim 5.

17. The composition according to claim 7, wherein said enzyme hydrolysate is contained in an amount of from 0.01 to 1% by weight.

18. The composition according to claim 8, wherein said enzyme hydrolysate is contained in an amount of from 0.01 to 1% by weight.
